(19) United States
(12) Patent Application Publication
(10) Pub. No.: US 2014/0017525 A1
(43) Pub. Date: Jan. 16, 2014

(54) BATTERY COMPRISING A PLURALITY OF ELECTROCHEMICAL ENERGY STORES

(71) Applicant: Tim Schaefer, Harztor (DE)

(72) Inventor: Tim Schaefer, Harztor (DE)

(73) Assignee: LI-TEC BATTERY GMBH, Kamenz (DE)

(21) Appl. No.: 13/980,426

(22) PCT Filed: Jan. 9, 2012
(86) PCT No.: PCT/EP2012/000065

§ 371 Date: Oct. 1, 2013

(30) Foreign Application Priority Data
Jan. 18, 2011 (DE) 10 2011 008 792.3

(51) Int. Cl. H01M 10/42

(52) U.S. Cl. CPC H01M 10/4207
USPC 429/61

(57) ABSTRACT

The invention relates to a battery consisting of a plurality of electrochemical energy stores, a respective separator being positioned between said electrochemical energy stores and being designed in such a way that if specified preconditions are present or occur, a fire-retardant material or an extinguishing agent can be released from said separator.

The content of priority application DE 10 2011 008 792.3 is incorporated in its entirety in the present application by reference.

The present invention relates to a battery consisting of a plurality of electrochemical energy stores. Electrochemical energy stores are essential in an enormous range of applications and are accordingly incorporated in very different environments, and are used according to the requirements of the applications in various arrangements, in which a plurality of electrochemical energy stores are connected to form a battery for ensuring the supply of voltage or capacity appropriate to the requirements of the application via a connection in series or in parallel of a plurality of electrochemical energy stores depending on the application.

In the context of such energy stores, fire prevention and/or firefighting is of particular importance. Particularly when such electrochemical energy stores are used in vehicles for carrying passengers, fire prevention or firefighting is a very important element in increasing the safety of such energy stores.

Document DE 10 2008 059 948 A1 discloses a method and device for fire prevention and/or fire fighting with respect to a lithium-ion battery of a vehicle, particularly a motor vehicle, in which the interior compartment of the battery that contains the individual cells is connected to an extinguishing agent reservoir via an emergency line, and in which the interior of the battery and the extinguishing agent reservoir are at least intermittently in fluid communication via an emergency aperture.

Document DE 10 2008 059 942 A1 discloses a method and device for preventing and/or fighting fire in a vehicle, having a coolant circuit and a fire extinguishing device. The fire extinguishing device is provided with emergency apertures that are opened for firefighting and/or fire prevention, and through which an extinguishing agent can be discharged.

Document DE 10 2008 059 968 A1 discloses a method and apparatus for operating a lithium-ion battery of a vehicle, in which the interior of the battery that contains individual cells of the battery is in fluid connection with a coolant circuit via line for the purpose of fire prevention and/or firefighting, and in case of need the coolant is introduced at least intermittently into the interior.

The object of the present invention is to provide a technical teaching for fire prevention and/or fire fighting in the context of electrochemical energy stores and to the extent possible overcome limitations or disadvantages of known solutions to the problem. This object is solved by a product and a method according to one of the independent claims. The dependent claims are intended to obtain protection for advantageous refinements of the invention.

According to the invention, a battery consisting of a plurality of electrochemical energy stores is provided, between each of which a separative element is arranged and designed in such a manner that a fire-retarding material or extinguishing agent may be discharged from this separative element if certain conditions are present or occur.

In this context, the term electrochemical energy store is understood to mean a device that stores energy in chemical form and is able to release said energy to an external consumer in electrical form. Important examples of such energy stores are fuel cells and galvanic cells, also units consisting of a plurality of such cells. The cells are preferably secondary batteries, that is to say electrochemical energy stores that are able not only to release energy stored in chemical form as electrical energy to a consumer, but are also to store such energy in electrical form when electrical energy is applied, that is to say they are capable of being charged.

In this context, the term battery is understood to mean a three-dimensional collection of electrochemical energy stores, preferably with simultaneous interconnection of said electrochemical energy stores. The electrochemical energy stores are preferably located in a battery housing, in which prismatic electrochemical energy stores in particular are secured preferably by means of frames, which lend mechanical stability to the individual electrochemical energy stores or galvanic cells, which are preferably equipped with a film packaging. Separative elements are preferably arranged between the individual electrochemical energy stores, which preferably serve among other things to protect the three-dimensional collection of electrochemical energy stores from vibrations, shocks or other potentially harmful mechanical, thermal or other effects, to control the temperature of the individual electrochemical energy stores, particularly to cool them, and preferably also to deploy fire-retardant effects.

In this context, the term fire is understood to be any process in which the battery, an energy store or parts of an energy store or of its environment are converted or decomposed in an undesirable chemical reaction. In this sense, fires are particularly exothermal chemical reactions of parts or components of an energy storage device or of its surroundings, which frequently occur as a consequence of overheating of the energy stores or its components.

In this context, the term extinguishing agent is understood to be a substance or mixture of substances that has an extinguishing action, that is to say preferably an inhibiting effect on fires and/or prevents or hinders the occurrence of fires. In the context of the present invention, the term extinguishing effect is preferably understood to refer to an effect that is capable of counteracting a fire, that is to say preventing or mitigating the consequences or formation of a fire. Important examples of extinguishing agents or preferred ingredients thereof are substances that deprive a fire source of a chemical reaction partner without which the fire cannot be sustained, or that inhibit a chemical reaction which contributes to the initiation or continued existence of a fire. Extinguishing agents are preferably produced by mixing an extinguishing agent additive with a solvent or a carrier.

For the purposes of the present invention, preferred extinguishing agent additives are those known as gelling agents that combine with other materials, solvents or carrier substances such as, preferably, water, to form preferably adhesive and preferably viscous gels or viscoelastic fluids that are preferably characterised by their strong properties of adhesion to burning objects and the surfaces thereof. Gelling agents are preferred examples of extinguishing agent additives that are preferably based on superabsorbers, and which are preferably stored as powders or solids, or also as emulsions. Superabsorbers are often able to absorb many times their weight or volume in water or another carrier substance. Water-based gels that are formed from corresponding superabsorbers by mixing with water have an advantage over conventional foam blankets in that a hermetic barrier layer is formed that remains in place longer than conventional foam blankets and discharges considerably less water onto the combustible material.

In the context of the description of the present invention, a viscoelastic fluid is understood to be a fluid having the property of viscoelasticity. An (ideal) fluid is understood to be a substance that offers (practically) no resistance to slow shearing. A distinction is made between compressible fluids (gases) and incompressible fluids (liquids). The superordinate term “fluid” is used because most of the physical laws apply (approximately) equally for gases and liquids and many of their properties differ only quantitatively, in qualitative terms they are not fundamentally different from each other. Real fluids can be classified according to their behaviour as “Newtonian fluids”, with the “fluid mechanics” that describes them, and “non-Newtonian fluids” with the “rheology” that describes them. The difference consists in the flow behaviour of the medium, which is described by the functional relationship between the viscous stress or shear stress and the strain rate or shear rate.

Viscoelasticity is the term used to describe the time-, temperature- and/or frequency-dependent elasticity of fluids such as polymer melts or solids such as plastics. Viscoelasticity is characterised by a partly elastic, partly viscous behaviour. After an externally acting force is removed, the material does not return fully to its initial state; the remaining energy is dissipated in the form of flow processes.

In the context of the description of the present invention, a gel is understood to be a finely dispersed system of at least one first, often solid, and at least one second, often liquid, phase. A gel is frequently a colloid. The solid phase forms sponge-like, three-dimensional network, the pores of which are filled with a liquid or also gas. Both phases perfuse one another, often completely. The term colloid is used to describe particles or droplets that are finely dispersed in another medium (solid, gas or liquid), called the dispersion medium.

Other preferred extinguishing agents or fire-retardant materials in the context of the present invention are inert gases or mixtures of inert gases. In this connection, an inert gas is understood to be a gas or mixture of gases that is suitable for preventing or fighting a fire, preferably by eliminating a chemical reactant that is conducive to or necessary for the origination or persistence of fire, or displacing it from the area of the fire. Preferred examples of such inert gases are argon, nitrogen, carbon dioxide or mixtures thereof, such as Inergen® or Argonite®.

Generally in this context, all gases that do not react chemically with the combustible material and are capable of displacing possible reactants with the combustible material from the area of the fire are suitable for use as inert gases. Inergen® is a brand name for a mixture of nitrogen, argon and carbon dioxide that is used as an extinguishing agent for fire fighting or as a protective gas for active fire prevention. Inergen consists of 52 v/v % nitrogen, 40 v/v argon, and 8 v/v carbon dioxide (http://de.wikipedia.org/wiki/Inergen).

All components of INERGEN®—argon, nitrogen and carbon dioxide—are of natural origin. Argon and nitrogen are obtained from the ambient atmosphere, carbon dioxide from natural gas sources. After they are used to extinguish a fire they return unchanged to the atmosphere and do not pollute the environment. INERGEN® smothers fire by displacing oxygen and at the same time the carbon dioxide component ensures a supply of oxygen to the human body.

In a gas-filled room, the 8 v/v % CO2 content in the extinguishing agent can reach a concentration from 2.5-5.0 v/v %, depending on the risk of fire and the quantity of extinguishing agent. This low percentage affects the respiratory control system in the human body in such a manner that the lower oxygen supply in the area of the fire —reduced to 14 v/v % to 10 v/v %—is compensated for by an automatic increase in breathing rate (volume). The quantity of oxygen that arrives in the brain cells to maintain important body functions remains practically unchanged—even if individuals are unconscious. INERGEN® gas is thus an extinguishing agent that does not harm the human body. It puts out fires completely without residue and is one hundred percent environmentally neutral (http://www.totalwalther.de/inergen_loeschanlagen.htm).

With a density of 1.784 kg/cm³ at 0° C. and 1013 hPa, the noble gas argon is heavier than air. It is chemically very inert, and it is the cheapest of the noble gases and available in large quantities, so it is used in many industrial areas. Argon is used for preference as a protective gas when nitrogen cannot be used, for example in processes with metals that react chemically with nitrogen at high temperatures. Argon is non-toxic and is even used as a food additive (E938), is a preferred propellant and protective gas in food packaging and wine production. Because of its stifling effect, argon is a suitable gas-phase extinguishing agent and is used mainly for protecting property, particularly electrical and computer equipment (http://de.wikipedia.org/wiki/Argon).

Nitrogen is a colourless, non-poisonous gas which is heavier than air, with a density of 1.250 kg/cm³ at 0° C., and boils at 77.36 Kelvin. With a content of 78%, molecular nitrogen is the main component of the air we breathe. Like argon, nitrogen is approved as a food additive, and is used for example as a propellant, a packaging gas or with designation E941 for whipping cream. Nitrogen is used as a shielding gas in welding applications among others, and as a lamp filling gas. The inert properties of nitrogen are advantageous in this context too (http://de.wikipedia.org/wiki/Stickstoff).

Carbon dioxide is a colourless, odourless, non-combustible gas that only decomposes above 2000° C. to yield carbon monoxide and oxygen split and dissolves readily in water. With basic metal oxides or metal hydroxides, it forms two kinds of salts, which are called carbonates or bicarbonates respectively (http://de.wikipedia.org/wiki/Kohlenstoffdioxid). Carbon dioxide is a natural component of the air we breathe, in which it occurs in an average concentration of 0.038%. Due it its oxygen-displacing properties, carbon dioxide is used in firefighting, particularly in portable fire extinguishers and automatic fire extinguishing systems.

As a component of the inert gas Inergen®, carbon dioxide also renders Inergen suitable for fighting and preventing fires in areas frequented by humans. Carbon dioxide has an accelerating effect on human respiration in atmospheres with low oxygen levels, so people in areas flooded with Inergen can even survive in oxygen concentrations of barely more than 10 v/v %. Since many fires are already extinguished or do not even start in such low oxygen concentrations, fire prevention or firefighting with Inergen is often preferred to firefighting with other protective gases, because it helps to reduce the danger to humans.

Argonite® is a brand name for a mixture of approximately 50% argon and 50% nitrogen. Unlike Inergen, Argonite contains no admixture of carbon dioxide, with the consequence that the possibly life-saving effects of the carbon dioxide admixture in Inergen are not present with Argonite, but this may sometimes be advantageous since undesirable effects on living organisms or chemical reactions with an admixture of carbon dioxide do not have to be anticipated when using Argonite.

Besides the above-mentioned inert gases such as argon or nitrogen or mixtures thereof such as Inergen or Argonite, which may contain admixtures, preferably of carbon dioxide, other compounds that are mostly gaseous under normal conditions and have a flame-retardant, fire-preventing or suffocating effect are also conceivable for use as inert gases for the purposes of the present invention.

These also include for example fluoroform or its haloform analogues, in which the fluorine content is replaced by another halogen. Fluoroform has chemical formula CHF, and is used as a fire extinguishing agent in various applications for which its generally low toxicity, low chemical reactivity and high density appears to render it suitable. Fluoroform is marketed commercially by DuPont under the brand name FE-13.

Another inert gas that may be considered in the context of the present invention is 1,1,1,2,3,3,3-heptafluoropropane, which is also known by the trade names HFC-20720 or HFC-227ea. This is an odourless, colourless, gaseous halocarbon. It is commonly used as a gaseous fire extinguishing agent. The extinguishing agent is preferably suitable for fighting fires in areas containing data processing and telecommunications equipment. Its extinguishing effect preferably occurs at concentrations between 6.25 v/v % and 9 v/v %. Below a concentration of 9 v/v %, the U.S. Environmental Protection Agency allows the use of this gas in rooms frequented by people. At very high temperatures, however, heptanefluoropropane decomposes to form hydrogen fluoride.

Another compound that may be used as an inert gas in the context of the present invention is bromotrifluoromethane. Bromotrifluoromethane smothers conflagrations at a concentration of 6%.

Bromochlorodifluoromethane, also known as Halon 1211, is also conceivable for use as an inert gas in the context of the present invention.

Since some of the above halogen-containing compounds give cause for concern due to their environmentally harmful effects and use thereof has been limited to some degree by statutory provisions, a further compound should be cited at this point; it is known by the name Novec 1230. This is a product of 3M. The density of Novec 1230 is 1.723 g/cm³, which means that the gas is heavier than air. The compound is a liquid under normal conditions, so it can also be introduced into a fire area in liquid form.

Other gaseous or liquid compounds that cannot be listed fully here for reasons of space are also suitable for use as inert gases or inert gas mixtures in the context of the present invention.

According to a preferred embodiment of the invention, it is provided that the discharge of a fire retarding or fire extinguishing material from the separative element is triggered by a signal from a control means. A control device of such kind is preferably a “battery management system”, which preferably includes sensors for detecting the measurement variables that may be indicative of a fire or its possible development. Preferred examples of such measurement variables are temperatures of battery components or gases in the spaces between battery components, pressures, partial pressures or concentrations of chemical substances whose presence at certain concentrations may be indicative of a fire or its possible development.

Such control devices process the measurement variables captured by the sensors, preferably according to programmed algorithms or in accordance with an electronically represented logic, preferably using at least one processor, to create preferably at least one signal that triggers the discharge of a fire retarding material or extinguishing agent from the separative element. Electronically actuatable valves, igniters or other actuators are preferably used for this purpose, with the aid of which an electronic signal may be converted into a mechanical, pneumatic, hydraulic, thermal or other effect.

According to a further preferred embodiment of the invention, the features of which may also be combined with features of other embodiments of the invention, it is provided that the discharge of a fire retardant or fire extinguishing material from the separative element is effected without the action of a signal from a control device. In these cases, the separative element is preferably designed in such a manner that a change in certain physical or chemical parameters that is indicative of a fire or the possible development thereof causes a physical or chemical reaction in the separative element or at least one of the components thereof, resulting in the discharge of a fire retarding or fire extinguishing material without the action of a signal from a control device. In this case, such a trigger may be provided if certain preset break points are exceeded, or the ignition of a preferably exothermic chemical reaction or a similar physical or chemical reaction of the separative element or at least one of the components thereof. These embodiments of the invention have the advantage that the discharge of a fire retarding or fire extinguishing material from the separative element may then take place even if a control device provided according to other embodiments of the invention has failed or been damaged.

According to a further preferred embodiment of the invention, the features of which may also be combined with features of other embodiments of the invention, it is provided that the discharge of a fire retardant or fire extinguishing material from the separative element is triggered by an increase in the temperature of a material in the interior, on the surface or in the vicinity of a separative element. Temperature sensors are preferably provided in the interior, on the surface or in the vicinity of a separative element, and the signals therefrom are preferably processed by a control device such as a battery management system in order to trigger the discharge of a fire retardant or fire extinguishing material in response to a developing or existing fire. In other preferred embodiments of the invention an increase in the temperature of a material in the interior, on the surface or in the vicinity of a separative element triggers a physical or chemical reaction, preferably the ignition of an exothermic reaction, the energy of which is at least partially used in such cases to initiate a process that triggers the discharge of a fire retardant or fire extinguishing material from the separative element.

According to a further preferred embodiment of the invention, the features of which may also be combined with features of other embodiments of the invention, it is provided that the discharge of a fire retardant or fire extinguishing material from the separative element is triggered by an increase in the concentration of a material in the interior, on the surface or in the vicinity of the separative element. Chemical sensors are preferably provided inside, on the surface or in the vicinity of a separative element, and the signals therefrom are preferably processed by a control device such as a battery management system in order to trigger the discharge of a fire retardant or fire extinguishing material in response to a developing or existing fire. In other preferred embodiments of the invention an increase in the concentration of a material in the interior, on the surface or in the vicinity of a separative element triggers a physical or chemical reaction, preferably the ignition of an exothermic reaction, the energy of which is at least partially used in such cases to initiate a process that triggers the discharge of a fire retardant or fire extinguishing material from the separative element.

According to a further preferred embodiment of the invention, the features of which may also be combined with features of other embodiments of the invention, it is provided that the temperature of at least one fire retarding material or fire extinguishing agent exiting the separative element is lowered by expansion upon its exit from the separative element. Adiabatic expansion or isenthalpic expansion are preferably used in this context. The latter is also known as the Joule-Thomson effect.

In adiabatic expansion, the volume of a preferably gas-phase material or mixture of at least one gas and a solid or liquid, preferably finely dispersed flame retarding material or extinguishing agent is allowed to increase or expand in at least almost complete insulation from heat exchange with the environment. In this event, under certain conditions the temperature of the expanded material will fall as a consequence of thermodynamic state variables such as temperature and pressure as well as the chemical composition of the material, particularly the intermolecular forces in the material. These relationships are well known to a person skilled in thermodynamic engineering and therefore do not need to be explained here.

In isenthalpic expansion of a real gas through a choke, which is also known to a person skilled in thermodynamic engineering as the Joule-Thomson effect, under certain conditions the temperature of the expanded material will fall as a consequence of thermodynamic state variables such as temperature and pressure as well as the chemical composition of the material, particularly the intermolecular forces in the material. These relationships are the expert from the technical thermodynamics also well-known and therefore need not be shown here.

In these or other embodiments of the invention, the separative element preferably comprises at least one suitable nozzle or choke through which the material to be expanded adiabatically or isenthalpically can flow out of the separative element.

According to a further preferred embodiment of the invention, the features of which may also be combined with features of other embodiments of the invention, it is provided that at least areas of the separative element are designed as an elastic pad, cushion or balloon.

According to a further preferred embodiment of the invention, the features of which may also be combined with features of other embodiments of the invention, it is provided that the separative element is at least partly filled with a gaseous fire retarding material or extinguishing agent.

According to a further preferred embodiment of the invention, the features of which may also be combined with features of other embodiments of the invention, it is provided that the separative element is at least partly filled with a solid or liquid material that is at least partly converted to a liquid or gaseous state in the presence or upon the occurrence of certain conditions or when it leaves the separative element. This transition of the aggregate state preferably occurs as a result of a reduction in pressure, for example upon the rupture at a preset breaking point of a separative element that is designed at least is part as a pad, cushion or balloon, in particular through adiabatic or isenthalpic expansion of a gas, with which such a pad, cushion or balloon is at least partially filled.

According to a further preferred embodiment of the invention, the features of which may also be combined with features of other embodiments of the invention, it is provided that the at least partial transition to a liquid or gaseous state of at least one solid or liquid material is accompanied by a cooling effect in the separative element or upon the exit thereof from the separative element. The cooling effect is created preferably as a consequence of adiabatic or isenthalpic expansion, particularly preferably in combination with a subsequent evaporation process of a gas that has been liquefied by adiabatic or isenthalpic expansion, in which the vaporising or evaporating liquid extracts heat from its surroundings, thereby cooling its surroundings.

According to a further preferred embodiment of the invention, the features of which may also be combined with features of other embodiments of the invention, it is provided that at least one separative element is arranged between at least one housing wall of the battery and at least one electrochemical energy store.

According to a further preferred embodiment of the invention, the features of which may also be combined with features of other embodiments of the invention, it is provided that at least one separative element comprises a first frame that is connected to at least one second frame of at least one electrochemical energy store adjacent to said separative element.

In the following, the invention will be described in greater detail with reference to preferred embodiments and with the aid of the drawing. In the drawing:

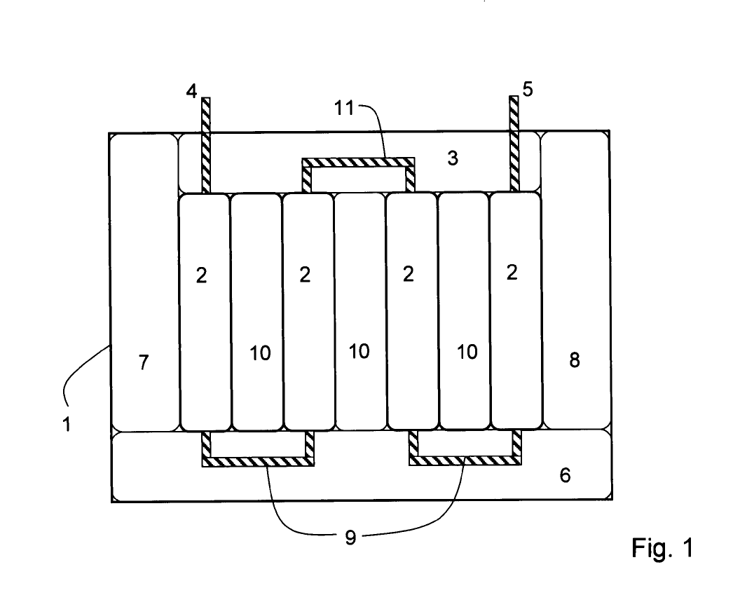

FIG. 1 is a diagrammatic representation of a preferred embodiment of a battery according to the invention;

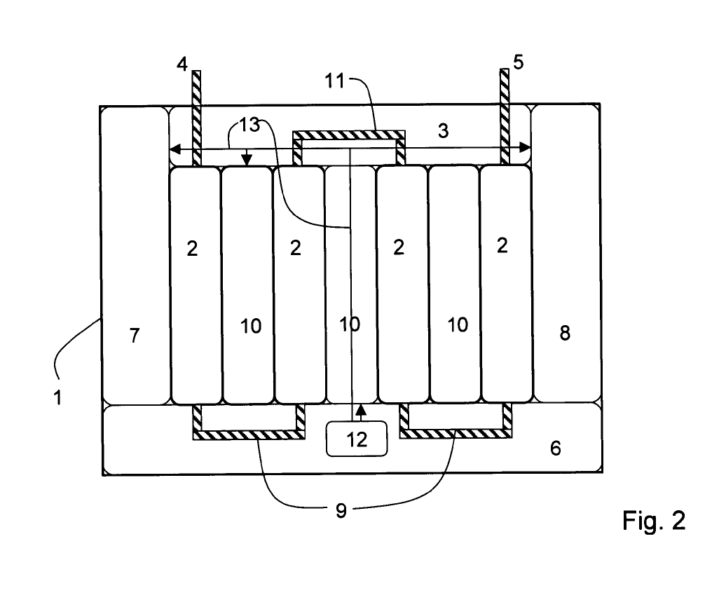

FIG. 2 is a diagrammatic representation of another preferred embodiment of a battery according to the invention.

The exemplary embodiments illustrated in the two figures show a battery consisting of a plurality of electrochemical energy stores 2, with a separative element 10 arranged between each. The electrochemical energy stores are connected in series by electrical conductors 9 and 11, and the electrical connectors of the end energy stores extend to the exterior via collectors 4 and 5. Separative elements 3, 6, 7 and 8 are arranged between the walls, the cover plate and/or bottom plate of battery housing 1 and energy stores 2. Some or all of said separative elements are preferably designed as elastic pads, cushions or balloons. In this way, energy stores 2 may be protected from the harmful or destructive effects of vibration or impacts. Thus, the separative elements are also helpful in providing a mechanical protection effect for the energy stores in addition to the flame retarding or fire extinguishing effects thereof.

The embodiment shown in FIG. 2 also shows a controller 12, which is preferably able to generate signals in response to sensors and transmit said signals to the separative elements 13, which are able to trigger the discharge of a flame retarding material or fire extinguishing agent from the separative element on the basis thereof.

1-12. (canceled)

13. A battery comprising:
a plurality of electrochemical energy stores, between each of which a separative element is arranged, wherein at least one separative element is configured so that the presence or occurrence of certain conditions trigger the discharge of a fire retarding material or fire extinguishing agent from said separative element.

14. The battery according to claim 13, wherein the separative element is configured such that the discharge of a fire retarding material or fire extinguishing agent from the separative element is triggered by a signal from a control device.

15. Battery according to claim 13, wherein the separative element is configured such that the discharge of a fire retarding material or fire extinguishing agent from the separative element is triggered without the influence of a signal from a control device.

16. The battery according to claim 13, wherein the separative element is configured such that the discharge of a fire retarding material or fire extinguishing agent from the separative element is triggered by the increase in temperature of a material located inside, on the surface, or in the vicinity of the separative element.

17. The battery according to claim 13, wherein the separative element is configured such that the discharge of a fire retarding material or fire extinguishing agent from the separative element is triggered by the increase in concentration of a material located inside, on the surface, or in the vicinity of the separative element.

18. The battery according to claim 13, wherein the battery is configured such that a temperature of at least one fire retarding material or fire extinguishing agent is lowered by expansion as it exits the separative element.

19. The battery according to claim 13, wherein the separative element is designed as an elastic pad, cushion or balloon.

20. The battery according to claim 13, wherein the separative element is at least partially filled with a gaseous fire retarding material or fire extinguishing agent.

21. The battery according to claim 13, wherein the separative element is at least partially filled with a solid or liquid material which is configured to be at least partially converted into a liquid or gaseous state in the presence or upon the occurrence of certain conditions or when it leaves the separative element.

22. The battery according to claim 21, wherein the battery is configured such that the at least partial transition to a liquid or gaseous state of at least one solid or liquid material in the separative element or upon the discharge thereof from the separative element is accompanied by a cooling effect.

23. The battery according to claim 13, wherein at least one separative element is arranged between at least one housing wall of the battery and at least one electrochemical energy store.

24. The battery according to claim 13, wherein at least one separative element comprises a first frame, which is connected to at least one second frame of at least one electrochemical energy store adjacent to said separative element.
